(19) United States
(12) Patent Application Publication
(10) Pub. No.: US 2024/0243779 A1
(43) Pub. Date: Jul. 18, 2024

(54) AUTOMATED CHANNEL CHARACTERIZATION FOR MACHINE-LEARNING-BASED RIS-AIDED MIMO SYSTEMS

(71) Applicant: Tektronix, Inc., Beaverton, OR (US)

(72) Inventors: Kan Tan, Portland, OR (US); Keith R. Tinsley, Beaverton, OR (US); John J. Pickerd, Hillsboro, OR (US)

(21) Appl. No.: 18/412,151

(22) Filed: Jan. 12, 2024

Related U.S. Application Data
(60) Provisional application No. 63/439,846, filed on Jan. 18, 2023.

(51) Int. Cl. H04B 7/04; H04B 7/0413

(52) U.S. Cl. CPC H04B 7/04013; H04B 7/0413

(57) ABSTRACT

A method of characterizing a communication channel includes receiving a first signal from a set of transmitters reflected along a reflected channel from each element of a reconfigurable intelligent surface (RIS) set at a nominal angle, receiving a second signal reflected in the reflected channel from each element of the RIS set at an adjusted angle, using the first and second signals to determine a transfer function for a combined channel comprised of a reflected channel and a direct channel, and using the transfer function as an input to a machine learning network to determine optimized settings for the elements of the RIS. A communications system includes a set of transmitters, a reconfigurable intelligent surface (RIS), one or more receivers positioned to receive signals reflected by the RIS from the set of transmitters, and a machine learning system configured to produce optimized angles for elements of the RIS.

### CROSS-REFERENCE TO RELATED APPLICATIONS

This disclosure claims benefit of U.S. Provisional Application No. 63/439,846, titled “AUTOMATED CHANNEL CHARACTERIZATION FOR MACHINE-LEARNING-BASED RIS-AIDED MIMO SYSTEMS,” filed on Jan. 18, 2023, the disclosure of which is incorporated herein by reference in its entirety.

### TECHNICAL FIELD

This disclosure relates to test and measurement systems, and more particularly to systems and methods for automated channel characterization in, inclusive but not limited to, a wireless communication system.

### BACKGROUND

The reconfigurable intelligent surface (RIS) technology is a spectral efficient and cost-effective approach for wireless communications systems. The phases of the RIS are the key tuning parameters that optimize the spectrum efficiency (SE) of the RIS-aided Multiple Input Multiple Output (MIMO) systems.

FIG. 1 shows an embodiment of a communication system. The transmitter location 10 has multiple transmitters, the RIS 12 has multiple elements, and the receiver 14 may comprise multiple receivers, such as mobile stations, or, in the case of a system to perform the channel characterization, a test and measurement instrument such as a spectrum analyzer. The communication system has a transmission path between the transmitters to the RIS with the transfer function Hₜ, a reception or receiver path between the RIS and the receivers with the transfer function Hᵣ, and a direct path between the transmitters and receivers with the transfer function H_{d}.

A machine learning-based reconfigurable intelligent surface (RIS)-aided MIMO system is introduced in N. T. Nguyen, Ly V. Nguyen, T. Huynh-The, D. H. N. Nguyen, A. L. Swindlehurst, and M. Juntti, “Machine Learning-based Reconfigurable Intelligent Surface-aided MIMO Systems” arXiv, 2021, available: arXiv:2105.00347 (hereinafter “Nguyen, et. al.). The approach assumes the channel state information (CSI) is known. The ML approach improves the speed to get the optimal RIS phases. The optimization problem is non-convex.

That approach uses the full channel state information (CSI) to formulize the phase optimization problem into a form solvable using machine learning. The portion of the inputs to the deep neural network in the approach that relate to the reflecting paths are the combination of the transfer function Hₜ of the path from the transmitters to the RIS, and the transfer function Hᵣ of the path from the RIS to the receivers.

### BRIEF DESCRIPTION OF THE DRAWINGS

FIG. 1 shows an embodiment of a communication system.

FIG. 2 shows a diagram of an embodiment of a method of characterizing a combined channel.

FIG. 3 shows a diagram of another embodiment of a portion of a method of characterizing a combined channel.

FIG. 4 shows a flowchart of an embodiment of a method of determining a transfer function for characterizing a combined channel.

FIG. 5 shows a graphical representation of a communication system optimizing spectral efficiency for multiple areas.

### DETAILED DESCRIPTION

The embodiments herein involve an automated way to characterize the transfer functions for both the direct path and the reflecting paths. Instead of getting the separate channel transfer functions, Hₜ, from the transmitters to the RIS, and the channel transfer functions from the RIS to the receivers, Hᵣ, the embodiments only use the combined transfer functions for the reflecting paths. The combined transfer functions for the reflecting paths include the channels from the transmitters to the RIS, the phases of the RIS, and the channels from the RIS to the receivers. To reduce the impact from the AWGN (additive white Gaussian noise), a least mean squares (LMS) approach is designed for channel characterization. The ML-based RIS phase optimization problem can now use the combined channel characterizations, where the combined channel is the combination of the channel from the RIS to the receivers and the direct channel.

The embodiments herein involve an alternative approach that involves simplified channel characterization process for the ML based RIS-aided MIMO systems.

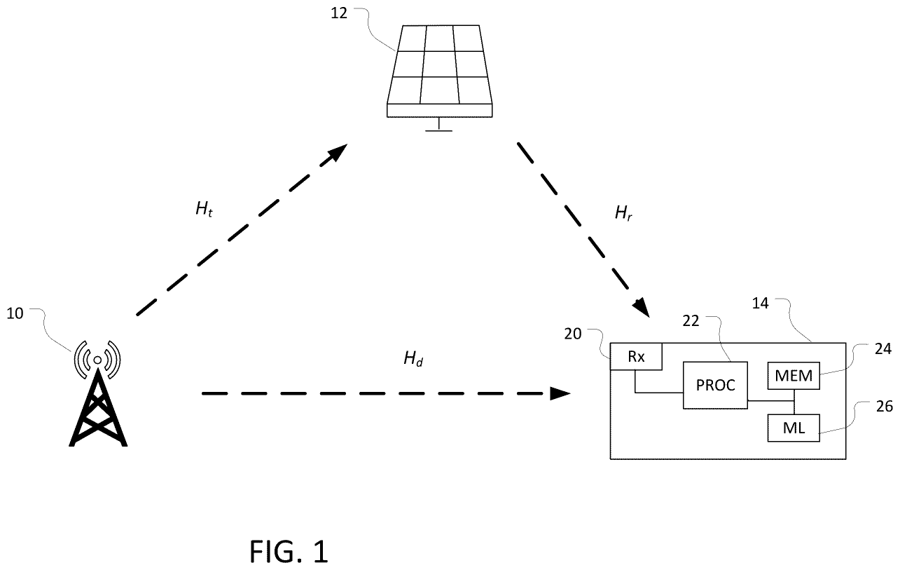

The process begins by adjusting the RIS phases from the nominal phases. In the RIS-aided MIMO system shown in FIG. 1, the received signal vector at the receiver, for example, a mobile station, can be expressed as

$$y = {H}_{d} x + {H}_{r} Φ {H}_{t} x + n = Hx + n , \qquad ( 1 )$$

where y ∈ [symbol] ^{N}^{ᵣ}^{×1} is the received vector. H_{d} ∈ [symbol] ^{N}^{ᵣ}^{×N}^{ₜ} is the transfer function of the direct channel from the transmitter, for example, the base station (BS), to the receiver. Hₜ ∈ [symbol] ^{N×N}^{ₜ} is the transfer function of the channel from the transmitter to the RIS. Hᵣ ∈ [symbol] ^{N}^{ᵣ}^{×N} is the transfer function of the channel from the RIS to the receiver. The term Φ=diag{α₁, α₂, . . . , α_{N}} comprises the diagonal reflecting matrix of the RIS. The term n˜CN(0, σ²I_{N}_{ᵣ}) comprises the complex additive white Gaussian noise (AWGN) at the receiver. The term x∈ [symbol] ^{N}^{ₜ}^{×1} comprises the transmitted vector. Passive beamforming designs may have an assumption of a uniform power allocation, i.e., { [symbol] xx^{H}} _P_{BS}I_{N}_{ₜ}, where P_{BS} is the transmit power at the BS. H is the transfer function of the combined effective channel:

$$H \hat{=} {H}_{d} + {H}_{r} Φ {H}_{t} \qquad ( 2 )$$

The reflecting matrix element α₁ can be represented by the phase θᵢ:

$${α}_{i} = {e}^{j {θ}_{i}} \qquad ( 3 )$$

$$for$$

$$i = 1 , 2 , … , N$$

Note that a diagonal matrix represents the reflecting matrix of the RIS, meaning a matrix in which all elements equal 0 except for those in which i=j, where i is the row index and j is the column index of the element. The elements of the RIS are indexed with i. The combined effective channel H can be rewritten as

$$H = {\sum }_{i = 0}^{N} {e}^{j {θ}_{i}} {\overline{H}}_{( i )} \qquad ( 4 )$$

With θ₀=0, H̅₍₀₎=H_{d} and H̅₍ᵢ₎ equals the i-th column of Hᵣ multiplied with the i-th row of Hₜ for i=1, 2, . . . , N. H_{d}, as mentioned above, represents the transfer function of the direct channel between the transmitters and the receiver.

To find the phases that optimize spectrum efficiency (SE), it is sufficient to have the values of H̅₍ᵢ₎ in (4), instead of knowing Hᵣ and Hₜ individually as in the current state of the art represented by Nguyen, et. al. To further simplify the problem, let θ̅ᵢ denote the initial phase, or the nominal phase, of the RIS element i. When the phase is adjusted by Δθᵢ from the initial phase, the phase becomes.

$${θ}_{i} = {\overline{θ}}_{i} + Δ {θ}_{i} \qquad ( 5 )$$

The combined effective channel H can therefore be rewritten as

$$H = {\sum }_{i = 0}^{N} {e}^{j Δ {θ}_{i}} ( {e}^{j {\overline{θ}}_{i}} {\overline{H}}_{( i )} )$$

where the discussion will call the transfer function H̅₍ᵢ₎ the transfer function of the reflecting paths associated with the i-th reflecting element of the RIS.

Denote

$${\tilde{H}}_{( i )} = {e}^{j {\overline{θ}}_{i}} {\overline{H}}_{( i )} \qquad ( 6 )$$

where the discussion will call the transfer function \tilde{H}₍ᵢ₎ the transfer function of the channel with the nominal angle for the i-th reflecting element of the RIS.

$$H = {\sum }_{i = 0}^{N} {e}^{j Δ {θ}_{i}} {\tilde{H}}_{( i )} \qquad ( 7 )$$

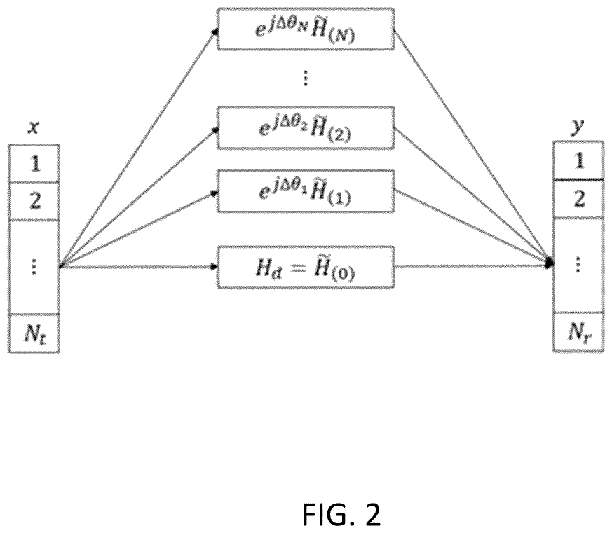

with \tilde{H}₍₀₎=H_{d}, Δθ₀=0 for the direct path. FIG. 2 represents the RIS-aided system. The designation x identifies the transmitter vector of transmitters 1 through Nₜ, the number of transmitters. The RIS has elements indexed i from 1 to a number of reflecting elements, N. The designation y identifies the receiver vector of receivers 1 through Nᵣ, the number of receivers. When the matrix, \tilde{H}, is populated for each transmitter, receiver, and reflecting element, it becomes the transfer function of the combined channel.

As mentioned in Nguyen, et. Al., the SE of the RIS-aided MIMO system can be expressed as:

$$SE ( \{ {α}_{i} \} ) = {log}_{2} det ( {I}_{{N}_{r}} + ρ {HH}^{H} ) , \qquad ( 8 )$$

where {αᵢ}={α₁, α₂, . . . , α_{N}} is the set of the phases at the RIS that needs to be optimized, and

$$ρ = \frac{{P}_{BS}}{{σ}^{2}} .$$

Equivalently, the H is a function of {Δθᵢ} in (7), the SE can be re-written as

$$SE ( \{ Δ {θ}_{i} \} ) = {log}_{2} det ( {I}_{{N}_{r}} + ρ {HH}^{H} ) . \qquad ( 9 )$$

The policy-based forwarding (PBF) design that maximizes the SE can be formulated as

$$\\ \begin{matrix}( P 0 ) {max}_{\{ Δ {θ}_{i} \}} SE ( \{ Δ {θ}_{i} \} ) & ( 10 )\end{matrix}$$

{Δθᵢ} are within the allowed phase adjustment ranges from the nominal phases of the RIS-aided system.

The process then moves to acquiring the automated channel characterization (ACC) with a Least Mean Squares (LMS) approach. To get the optimal RIS phases, the \tilde{H}₍ᵢ₎ in (6) needs to be characterized. For the same transmitter vector x, when the phases in RIS are changed, the received vector y changes. To characterize \tilde{H}₍ᵢ₎, turn on one of the transmitters, for example, the p-th transmitter to transmit a known signal vₚ, and turn off all other transmitters. The transmitted signal vₚ can be characterized beforehand. The transmitter vector is.

$$\\ {x}_{p} = [ \begin{matrix}0 \\ ⋮ \\ {v}_{p} \\ ⋮ \\ 0\end{matrix} ]$$

Set the RIS with the nominal phases θ̅, the received vector is.

$$\\ \begin{matrix}{y}_{p , 0} = {H}_{d} {x}_{p} + {\sum }_{m = 1}^{i - 1} {\tilde{H}}_{( m )} {x}_{p} + {\tilde{H}}_{( i )} {x}_{p} + {\sum }_{m = i + 1}^{N} {\tilde{H}}_{( m )} {x}_{p} + {n}_{p , 0} & ( 11 )\end{matrix}$$

Then adjust i-th phase by Δθ_{i,1} in RIS, the received signal is.

$$\\ \begin{matrix}{y}_{p , 1} = {H}_{d} {x}_{p} + {\sum }_{m = 1}^{i - 1} {\tilde{H}}_{( m )} {x}_{p} + {e}^{{}_{} j Δ {θ}_{i \text{.1}}} {\tilde{H}}_{( i )} {x}_{p} + {\sum }_{m = i + 1}^{N} {\tilde{H}}_{( m )} {x}_{p} + {n}_{p , 1} & ( 12 )\end{matrix}$$

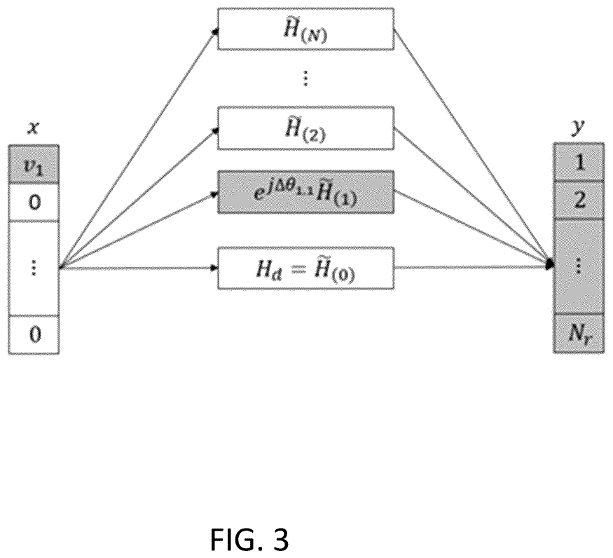

FIG. 3 shows an example with the first transmitter turned on and adjusting the phase of the first RIS element. The gray boxes represented the active transmitter, and the transfer function applied and the receivers.

Subtract (11) from (12) to get.

$$\\ \begin{matrix}{y}_{p , 1} - {y}_{p , 0} = ( {e}^{{}_{} j Δ {θ}_{i , 1}} - 1 ) {\tilde{H}}_{( i )} {x}_{p} + {n}_{p , 1} - {n}_{p , 0} & ( 13 )\end{matrix}$$

As n_{p,1}−n_{p,0} is an AWGN, the p-th column of \tilde{H}(i) can be estimated by

$$\\ \begin{matrix}{\tilde{H}}_{( i )} ( : , p ) = \frac{{y}_{p , 1} - {y}_{p , 0}}{{v}_{p} ( {e}^{{}_{} j Δ {θ}_{i , 1}} - 1 )} & ( 14 )\end{matrix}$$

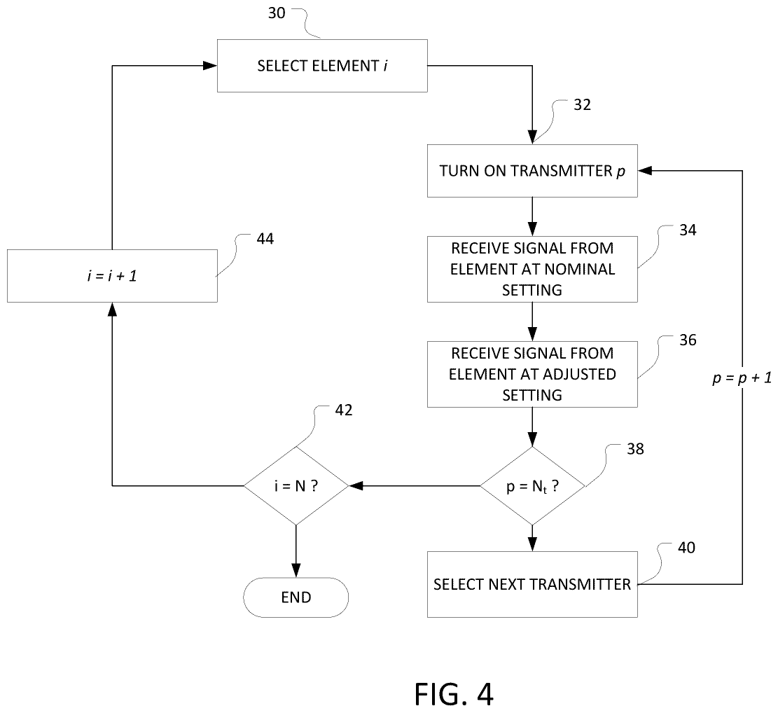

FIG. 4 shows a flowchart representation of this process. By sweeping the transmitter index, p, from 1 to Nₜ, all the columns of the nominal transfer function, \tilde{H}₍ᵢ₎, are obtained from Eq. (14). Then, by sweeping the RIS elements from i from 1 to N, all \tilde{H}₍ᵢ₎ are obtained for i=1, 2, . . . , N. In the embodiment of FIG. 4, the process selects one element of the RIS at 30, indexed by the variable i. The process starts by turning on only one transmitter at 32, initially the first transmitter, indexed by the variable p. The RIS element, set to its nominal angle, receives the signal from the first transmitter and produces a first received signal at 34. The process then sets the RIS to its adjusted angle and repeats the process at 36. If the current transmitter is not the last transmitter at 38, the process selects the next transmitter at 40, and repeats. If the current transmitter is the last transmitter, the process determines if there are more RIS elements at 42, selects the next RIS element at 44, and the process repeats. The process may also select one transmitter, then change the RIS elements through the entire array, then change to the next transmitter. No limitation to whether the transmitters or the RIS elements cycle within the outer loop is intended nor should any such limitation be implied. Once all transmitters and RIS elements have been selected, the process ends.

The above process populates the transfer function matrix, with the cycling through of the transmitters providing the values for the columns, the receivers providing the values for the rows, and the RIS elements providing the values for the i-th transfer function matrix. The process may stop here but may continue to improve the accuracy of the results.

To improve the accuracy of the channel characterization by reducing the impact of the AWGN, a LMS approach is designed: by turning i-th phase by multiple phases Δθ_{i,1}, Δθ_{i,2}, . . . , Δθ_{i,k}, k-instances of (13) are obtained, and can be written in a matrix form:

$$\\ \begin{matrix}[ \begin{matrix}{y}_{p , 1} - {y}_{p , 0} \\ {y}_{p , 2} - {y}_{p , 0} \\ ⋮ \\ {y}_{p , k} - {y}_{p , o}\end{matrix} ] = {v}_{p} [ \begin{matrix}( {e}^{{}_{} j Δ {θ}_{i , 1}} - 1 ) {I}_{{N}_{r}} \\ ( {e}^{{}_{} j Δ {θ}_{i , 2}} - 1 ) {I}_{{N}_{r}} \\ ⋮ \\ ( {e}^{{}_{} j Δ {θ}_{i , k}} - 1 ) {I}_{{N}_{r}}\end{matrix} ] {\tilde{H}}_{( i )} ( : , p ) + [ \begin{matrix}{n}_{p , 1} - {n}_{p , 0} \\ {n}_{p , 2} - {n}_{p , 0} \\ ⋮ \\ {n}_{p , k} - {n}_{p , 0}\end{matrix} ] & ( 15 )\end{matrix}$$

Let

$$\\ {Y}_{p} = [ \begin{matrix}{y}_{p , 1} - {y}_{p , 0} \\ {y}_{p , 2} - {y}_{p , 0} \\ ⋮ \\ {y}_{p , k} - {y}_{p , 0}\end{matrix} ] and {M}_{p} = {v}_{p} [ \begin{matrix}( {e}^{{}_{} j Δ {θ}_{i , 1}} - 1 ) {I}_{{N}_{r}} \\ ( {e}^{{}_{} j Δ {θ}_{i , 2}} - 1 ) {I}_{{N}_{r}} \\ ⋮ \\ ( {e}^{{}_{} j Δ {θ}_{i , k}} - 1 ) {I}_{{N}_{r}}\end{matrix} ]$$

The p-th column of \tilde{H}₍ᵢ₎ can be calculated from LMS as:

$$\\ \begin{matrix}{\tilde{H}}_{( i )} ( : , p ) = {( {M}_{p}^{{}_{} H} {M}_{p} )}^{- 1} ( {M}_{p}^{{}_{} H} {Y}_{p} ) & ( 16 )\end{matrix}$$

Note that (14) is a special case of (16) where k=1.

In summary, the ACC with LMS solution contains three loops. As discussed regarding FIG. 4, a first loop may iterate i from 1 to N to traverse the N elements in RIS \tilde{H}₍ᵢ₎. Within each element, a second loop may iterate p from 1 to Nₜ to traverse the columns of the \tilde{H}₍ᵢ₎(:, p). As discussed above, these may be interchanged. In order to increase the accuracy of the transfer function of the direct path, the process may optionally iterate from 1 to k to create multiple sets of data to enable the LMS solution (16) for \tilde{H}₍ᵢ₎(:, p) to improve the accuracy by reducing the impact of the AWGN. Each row of the matrices in Equation 15 represents one condition and each matrix represents conditions 1 through k. The LMS solution of Equation 16 solves these in matrix format, resulting in a single solution. The LMS solution uses the combined matrix Mₚ, and the receiver side combined vector Yₚ in Equation 16 to arrive at the LMS solution. This provides the transfer function for the reflected channel, which is part of the combined channel.

With \tilde{H}₍ᵢ₎ for i=1, 2, . . . , N been obtained, the transfer function for the direct path H_{d}=\tilde{H}₍₀₎ can be calculated from (11):

$$\\ \begin{matrix}{H}_{d} ( : , p ) = \frac{{y}_{p , 0}}{{v}_{p}} - {\sum }_{i = 1}^{N} {\tilde{H}}_{( i )} ( : , p ) & ( 17 )\end{matrix}$$

To reduce the impact of the AWGN noise on the result of H_{d}, (12) can also be used to calculate H_{d}:

$$\\ \begin{matrix}{H}_{d} ( : , p ) = \frac{{y}_{p , 1}}{{v}_{p}} - {\sum }_{m = 1}^{i - 1} {\tilde{H}}_{( m )} ( : , p ) - {e}^{{}_{} j Δ {θ}_{i \text{.1}}} {\tilde{H}}_{( i )} ( : , p ) - {\sum }_{m = i + 1}^{N} {\tilde{H}}_{( m )} ( : , p ) & ( 18 )\end{matrix}$$

Since each instance of all the iterations from the three loops generates a condition that can be used to calculate H_{d} with known \tilde{H}₍ᵢ₎ and Δθ_{i,:} for i=1, 2, . . . , N, averaging of H_{d} from all the instances yields the accurate result somewhat equivalent to the LMS solution above. In this case, each condition of Equation 18 is solved and then the solutions are averaged to generate the result for the directed channel. Returning to the discussion of the development of \tilde{H}₍ᵢ₎, \tilde{H}₍₀₎=H_{d}, so H_{d} is the first term of the \tilde{H}₍ᵢ₎, so increasing the accuracy of the first term increases the accuracy overall. Other aspects of the accuracy of H_{d} are discussed below regarding the vector input.

Once this characterization is completed, the results can employ machine learning to use the automated channel characterization to determine the appropriate settings for the RIS elements to set the elements to maximize spectral efficiency.

The arrangement for machine learning, such as in Nguyen, et. al., is revised to use the ACC results. The input to a deep neural network (DNN) is constructed as

$$\\ \begin{matrix}\tilde{h} = vec ( \{ ( {\tilde{H}}_{( i )} ) \} , \{ ( {\tilde{H}}_{( i )} ) \} ) ∈ {ℝ}^{2 {N}_{r} \times {N}_{t} ( N + 1 ) \times 1} & ( 19 )\end{matrix}$$

where [symbol] (A) and [symbol] (A) represent the real and imaginary parts of the entries of A. The term N+1 represents all the reflecting element plus the direct path. Referring to FIG. 1, the direct path is H_{d}. As mentioned above, having a more accurate H_{d} will result in more accurate results.

Both supervised and unsupervised training can be used. For the supervised training, the label is the optimized phase Δθ, which can be obtained using the conventional methods such as those in Nguyen, et. al. The vector above will be flattened as the input to the machine learning network. The data sets for supervised learning would result from many different channel conditions for each channel. Each resulting vector would be labeled with the optimized phase angle.

For the un-supervised training, the loss function for the neural network training can be set to

$$\\ \begin{matrix}Loss ( \{ Δ {\hat{θ}}_{i} \} ) = {log}_{2} det ( {I}_{{N}_{r}} + {ρ}_{train} {H}_{train} {H}_{train}^{{}_{} H} ) & ( 20 )\end{matrix}$$

Where βₜᵣₐᵢₙ is a random number in the range of [−ρ₀, ρ₀] dB, for example, ρ₀ is set to 30 dB in Nguyen, et. al., and

$$\\ {H}_{train} = {H}_{d , train} + {e}^{{}_{} j Δ \hat{θ}} {\tilde{H}}_{train}$$

Both H_{d,train} and each of the N elements of \tilde{H}ₜᵣₐᵢₙ are normalized so that their entries have zero-mean and unit-variance.

Returning to FIG. 1, the receiver may comprise a test and measurement instrument, or a device capable of performing test and measurement. The receiver may have one or more processors, represented by 22, a receiver 20 that allows it to receive the signals, a memory 24 that may contain code executable by the processor to measure the received signal and perform the methods of the embodiments. The receiver 14 may also contain a machine learning network, or a connection to a machine learning network, 26. In addition, the processor may send control signals to one or both of the transmitters and the RIS.

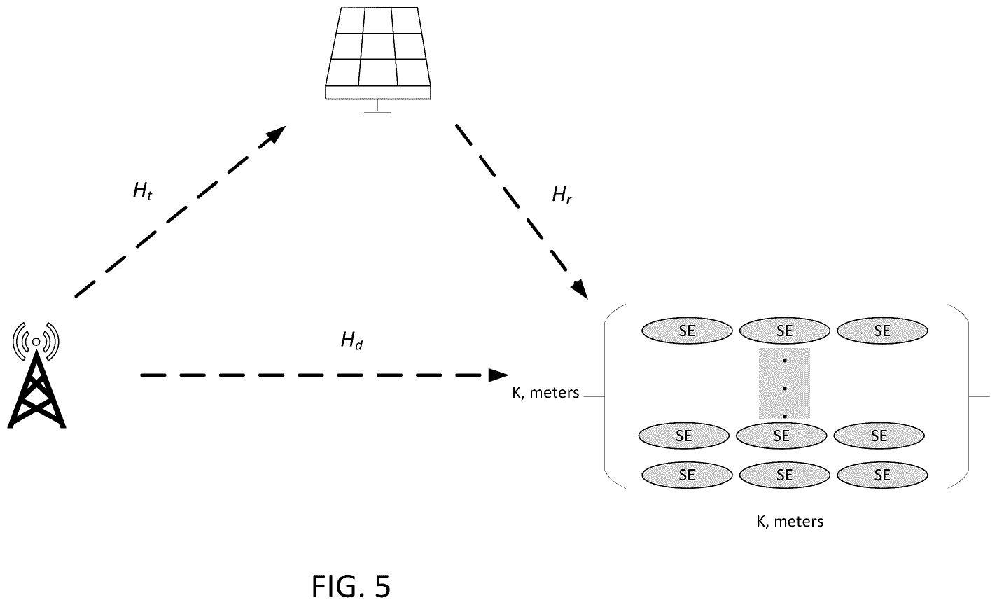

For the wireless communication system that covers various areas, the goal is to get the best SE for an area. For example, as shown in FIG. 5, the SE needs to be optimized for the K×K area. Each region within the K×K area may have a different SE than other regions within the larger area. This is supported by generalizing the math framework by making the receiver vector y with a high enough dimension, Nᵣ, to cover the whole area. By flexing the number of receivers, Nᵣ, the solution for the optimization for the area stays the same as the solution for a single ρosition. In practice, Nᵣ acts as one of the control parameters. A weighting function can be added the vector y, used above to determine the transfer function for the combined channel. The designer can put various weights on different locations, so the RIS phase optimization takes weight into account. The weight function is incorporated into the normalization step described in previous section.

The embodiments therefore provide an alternative approach that simplifies channel characterization process for the ML based RIS-aided MIMO systems. The characterization process can be fully automated, the LMS approach improves the accuracy of the channel characterization. This provides a built-in constant calibration methodology that ensures optimal beam alignments between the BS, RIS, and User Equipment MIMO systems. The process of the embodiments and associated services are employed before, or in parallel, with existing nominal communication operations. This leads to a unique platform providing hardware, software, and services that ensure monitoring and maintaining of optimal performance metrics.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### Examples

Illustrative examples of the disclosed technologies are provided below. An embodiment of the technologies may include one or more, and any combination of, the examples described below.

Example 1 is a method of characterizing a communication channel, comprising: receiving, at one or more receivers, a first signal from a set of transmitters reflected along a reflected channel from each element of a reconfigurable intelligent surface (RIS) set at a nominal angle; receiving a second signal reflected in the reflected channel from each element of the RIS set at an adjusted angle; using the first and second signals to determine a transfer function for a combined channel comprised of the reflected channel and a direct channel between the transmitters and the one or more receivers; and using the transfer function as an input to a machine learning network to determine optimized settings for the elements of the RIS.

Example 2 is the method of Example 1, further comprising setting the RIS elements to the optimized settings.

Example 3 is the method of either of Examples 1 or 2, further comprising repeating the receiving of the first signal and the second signal, the repeating comprising: receiving the first signal and the second signal from one element of the RIS for each of a set of transmitters; and repeating the receiving of the first signal and the second signal from one element of the RIS for each element of the RIS.

Example 4 is the method of Example 3, wherein receiving the first signal and the second signal from one element of the RIS for each transmitter occurs before the repeating of the receiving from one element for each element of the RIS.

Example 5 is the method of Example 3, wherein receiving the first signal and the second signal for each element of the RIS occurs before the receiving for each transmitter.

Example 6 is the method of any of Examples 1 through 5, further comprising repeating the receiving the first signal, the receiving the second signal, and using the first and second signals, for multiple adjusted angles producing multiple matrices.

Example 7 is the method of Example 6, further comprising: using the multiple matrices to produce a combined matrix and a receiver side combined vector; using the combined matrix and the receiver side combined vector to produce a least mean square (LMS) result for the reflected channel; and using the LMS result to produce a transfer function for the reflected channel of the combined channel.

Example 8 is the method of Example 6, further comprising: using the multiple matrices to produce multiple transfer functions for the combined channel; using the multiple transfer functions for the combined channel to produce an averaged transfer function for the direct channel; and using the averaged transfer function for the direct channel of the combined channel.

Example 9 is the method of any of Examples 1 through 9, wherein using the machine learning network comprises using a supervised learning network.

Example 10 is the method of Example 8, wherein using a supervised learning network comprises: obtaining an optimized phase angle for each of multiple channels for multiple conditions; and using the multiple conditions for each channel as a data set labeled with the optimized phase angle across the multiple channels as data sets for the supervised machine learning network.

Example 11 is the method of any of Examples 1 through 10, wherein using the machine learning network comprises using unsupervised learning with a vector derived from the transfer function of the combined channel as an input.

Example 12 is the method of Example 11, wherein the vector uses one of an averaged transfer function of the direct channel, or a least mean squares (LMS) result.

Example 13 is the method of any of Examples 1 through 12, wherein determining the optimized settings for the elements of the RIS comprises: determining a weight for each of several different regions within a larger region for a received vector used in determining the transfer function for the combined channel; and using the weight for each region in determining the optimized settings for the elements of the RIS for that region.

Example 14 is a communications system, comprising: a set of transmitters; a reconfigurable intelligent surface (RIS) having an array of elements; one or more receivers positioned to receive signals reflected by the RIS from the set of transmitters; and a machine learning system configured to produce optimized angles for the elements of the RIS to maximize spectral efficiency of the communication system.

Example 15 is the communications system of Example 14, wherein one of the one or more receivers comprise a test and measurement instrument to receive the signals, the test and measurement instrument having one or more processors configured to execute code to cause the one or more processors to: receive, at one or more receivers, a first signal reflected in a reflected channel from the set of transmitters from each element of the reconfigurable intelligent surface (RIS) set at a nominal angle; receive a second signal reflected in the reflected channel from each element of the RIS set at an adjusted angle; use the first and second signals to determine a transfer function for a combined channel comprised of the reflected channel and a direct channel between the transmitters and the one or more receivers; and use the transfer function as an input to the machine learning system.

Example 16 the communications system of Example 15, wherein the one or more processors are further configured to execute code to cause the one or more processors to repeat the receive the first signal, the receive the second signal, and use the first and second signals, for multiple adjusted angles to produce multiple matrices.

Example 17 is the communications system of Example 16, wherein the one or more processors are further to execute code to cause the one or more processors to use the multiple matrices to produce a combined matrix and a receiver side combined vector; use the combined matrix and the receiver side combined vector to produce a least mean square (LMS) solution for the reflected channel; and use the LMS solution to produce a transfer function for the reflected channel of the combined channel.

Example 18 is the communications system of Example 16, wherein the one or more processors are further configured to execute code to cause the one or more processors to: use the multiple matrices to produce multiple transfer functions for the combined channel; use the multiple transfer functions for the combined channel to produce an averaged transfer function for the direct channel; and use the averaged transfer function for the direct channel of the combined channel.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of the disclosure have been illustrated and described for purposes of illustration, it will be understood that various modifications may be made without departing from the spirit and scope of the disclosure. Accordingly, the disclosure should not be limited except as by the appended claims.

1. A method of characterizing a communication channel, comprising:
receiving, at one or more receivers, a first signal from a set of transmitters reflected along a reflected channel from each element of a reconfigurable intelligent surface (RIS) set at a nominal angle;
receiving a second signal reflected in the reflected channel from each element of the RIS set at an adjusted angle;
using the first and second signals to determine a transfer function for a combined channel comprised of the reflected channel and a direct channel between the transmitters and the one or more receivers; and
using the transfer function as an input to a machine learning network to determine optimized settings for the elements of the RIS.

2. The method as claimed in claim 1, further comprising setting the RIS elements to the optimized settings.

3. The method as claimed in claim 1, further comprising repeating the receiving of the first signal and the second signal, the repeating comprising:
receiving the first signal and the second signal from one element of the RIS for each of a set of transmitters; and
repeating the receiving of the first signal and the second signal from one element of the RIS for each element of the RIS.

4. The method as claimed in claim 3, wherein receiving the first signal and the second signal from one element of the RIS for each transmitter occurs before the repeating of the receiving from one element for each element of the RIS.

5. The method as claimed in claim 3, wherein receiving the first signal and the second signal for each element of the RIS occurs before the receiving for each transmitter.

6. The method as claimed in claim 1, further comprising repeating the receiving the first signal, the receiving the second signal, and using the first and second signals, for multiple adjusted angles producing multiple matrices.

7. The method as claimed in claim 6, further comprising:
using the multiple matrices to produce a combined matrix and a receiver side combined vector;
using the combined matrix and the receiver side combined vector to produce a least mean square (LMS) result for the reflected channel; and
using the LMS result to produce a transfer function for the reflected channel of the combined channel.

8. The method as claimed in claim 6, further comprising:
using the multiple matrices to produce multiple transfer functions for the combined channel;
using the multiple transfer functions for the combined channel to produce an averaged transfer function for the direct channel; and
using the averaged transfer function for the direct channel of the combined channel.

9. The method as claimed in claim 1, wherein using the machine learning network comprises using a supervised learning network.

10. The method as claimed in claim 8, wherein using a supervised learning network comprises:
obtaining an optimized phase angle for each of multiple channels for multiple conditions; and
using the multiple conditions for each channel as a data set labeled with the optimized phase angle across the multiple channels as data sets for the supervised machine learning network.

11. The method as claimed in claim 1, wherein using the machine learning network comprises using unsupervised learning with a vector derived from the transfer function of the combined channel as an input.

12. The method as claimed in claim 11, wherein the vector uses one of an averaged transfer function of the direct channel, or a least mean squares (LMS) result.

13. The method as claimed in claim 1, wherein determining the optimized settings for the elements of the RIS comprises:
determining a weight for each of several different regions within a larger region for a received vector used in determining the transfer function for the combined channel; and
using the weight for each region in determining the optimized settings for the elements of the RIS for that region.

14. A communications system, comprising:
a set of transmitters;
a reconfigurable intelligent surface (RIS) having an array of elements;
one or more receivers ρositioned to receive signals reflected by the RIS from the set of transmitters; and
a machine learning system configured to produce optimized angles for the elements of the RIS to maximize spectral efficiency of the communication system.

15. The communications system as claimed in claim 14, wherein one of the one or more receivers comprise a test and measurement instrument to receive the signals, the test and measurement instrument having one or more processors configured to execute code to cause the one or more processors to:
receive, at one or more receivers, a first signal reflected in a reflected channel from the set of transmitters from each element of the reconfigurable intelligent surface (RIS) set at a nominal angle;
receive a second signal reflected in the reflected channel from each element of the RIS set at an adjusted angle;
use the first and second signals to determine a transfer function for a combined channel comprised of the reflected channel and a direct channel between the transmitters and the one or more receivers; and
use the transfer function as an input to the machine learning system.

16. The communications system as claimed in claim 15, wherein the one or more processors are further configured to execute code to cause the one or more processors to repeat the receive the first signal, the receive the second signal, and use the first and second signals, for multiple adjusted angles to produce multiple matrices.

17. The communications system as claimed in claim 16, wherein the one or more processors are further configured to execute code to cause the one or more processors to:
use the multiple matrices to produce a combined matrix and a receiver side combined vector;
use the combined matrix and the receiver side combined vector to produce a least mean square (LMS) solution for the reflected channel; and
use the LMS solution to produce a transfer function for the reflected channel of the combined channel.

18. The communications system as claimed in claim 16, wherein the one or more processors are further configured to execute code to cause the one or more processors to:
use the multiple matrices to produce multiple transfer functions for the combined channel;
use the multiple transfer functions for the combined channel to produce an averaged transfer function for the direct channel; and
use the averaged transfer function for the direct channel of the combined channel.
